(19) United States
(12) Patent Application Publication
(10) Pub. No.: US 2016/0143292 A1
(43) Pub. Date: May 26, 2016

(54) Anti-Microbial Compositions and Methods

(71) Applicant: NanoNano US, LLC, Dacula, GA (US)

(72) Inventor: Jerry Bond, Dacula, GA (US)

(73) Assignee: NanoNano US, LLC, Dacula, GA (US)

(21) Appl. No.: 15/013,455

(22) Filed: Feb. 2, 2016

Related U.S. Application Data
(63) Continuation of application No. PCT/US14/68324, filed on Dec. 3, 2014.
(60) Provisional application No. 62/072,152, filed on Oct. 29, 2014.

(51) Int. Cl. A01N 59/16; A01N 59/00

(52) U.S. Cl. CPC A01N 59/16; A01N 59/00

(57) ABSTRACT

A self-cleaning composition includes a metal oxide and, optionally, a second metal oxide. The self-cleaning composition can include an antimicrobial agent. The self-cleaning composition can be applied to a surface by electrostatic spraying. The self-cleaning composition and a composition including an antimicrobial agent can be applied to a surface either sequentially or simultaneously.

### CROSS-REFERENCE TO RELATED APPLICATIONS

This application is a continuation of International Patent Application No. PCT/US14/68324, filed Dec. 3, 2014, which in turn claims the benefit of U.S. Provisional Application Ser. No. 62/072,152 filed Oct. 29, 2014, entitled “Anti-Microbial Compositions and Methods,” each of which is incorporated by reference herein in its entirety.

### BACKGROUND OF THE INVENTION

The present invention generally relates to sanitization of surfaces and, more particularly, to compositions and methods for sanitization of a surface.

Disinfectants are products that are applied to surfaces or objects to kill any or all microorganisms. Depending on the way disinfectants have to be applied and used, they may not be completely intrusive into cracks and crevasses, especially where gravity will stop the flow of the liquid needed to be effective. This is very important because bacteria can hide in cracks and crevasses of equipment and surfaces, then grow if not eliminated by disinfection.

A major challenge is also the danger of inadequate training of workers who are often asked to perform cleaning and disinfecting duties faster and at lower costs.

### BRIEF SUMMARY OF THE INVENTION

A self-cleaning composition may include titanium dioxide and silicon dioxide. In some embodiments a self-cleaning composition may further include an antimicrobial agent, for example silver dihydrogen citrate.

A system for providing a self-cleaning coating may include a first composition that includes a first metal oxide and a second metal oxide; and a second composition that includes an antimicrobial agent. In some embodiments the first metal oxide may be titanium dioxide and in some embodiments the second metal oxide may be silicon dioxide. In some embodiments the antimicrobial agent may include silver dihydrogen citrate.

A method of sanitizing and/or disinfecting a surface may include applying to the surface a composition that includes a first metal oxide and a second metal oxide. In some embodiments the composition may be applied by electrostatic spraying. In some embodiments the first metal oxide may be titanium dioxide and in some embodiments the second metal oxide may be silicon dioxide. In some embodiments the antimicrobial agent may include silver dihydrogen citrate.

### BRIEF DESCRIPTION OF THE DRAWINGS

The foregoing summary, as well as the following detailed description of embodiments of the compositions and methods for sanitization of a surface, will be better understood when read in conjunction with the appended drawings of an exemplary embodiment. It should be understood, however, that the invention is not limited to the precise arrangements and instrumentalities shown.

In the drawings:

FIG. 1 is a cross-sectional view of a contaminated surface including crevices therein.

FIG. 2 is a cross-sectional view of a contaminated surface being treated with conventional spray and wipe to clean particles.

FIG. 3 is a cross-sectional view of a contaminated surface being treated with a composition in accordance with an exemplary embodiment of the present invention; and

FIG. 4 is a cross-sectional view of a surface after treatment with a composition in accordance with an exemplary embodiment of the present invention.

### DETAILED DESCRIPTION OF THE INVENTION

In some embodiments, a self-cleaning composition includes a metal oxide. In some embodiments, a self-cleaning composition includes titanium dioxide. In some embodiments, a self-cleaning composition includes titanium dioxide and further includes a second metal oxide. In some embodiments a self-cleaning composition further includes an antimicrobial agent. In some embodiments a self-cleaning composition further includes one or more additives, such as a surfactant and/or a dispersant.

The compositions, systems and methods of the invention may be used for micro-sized surface encapsulation of antimicrobial coatings over a self-cleaning photocatalyst base. The system of application may be applied daily, monthly, quarterly, as a single occurrence, or in the event of an emergency. The compositions, systems, and methods of the invention may allow for greater encapsulation of antimicrobial agents. In some embodiments an antimicrobial agent and a composition of the invention has a synergistic sanitization effect.

Compositions, systems, and methods of the invention provide a green approach to sanitization using a base photocatalyst coating in conjunction with an antimicrobial agent to deactivate and reduce initial microbial adhesion to surfaces. Without being limited by theory, the combination of sunlight or indoor conventional lighting with a photocatalyst, for example, titanium dioxide, creates molecular hydroxyl radicals and superoxide ions. These superoxide ions aggressively combine magnetically with surface contaminants. Once bound together, a chemical reaction takes place between the superoxide ions and the contaminants, effectively cleaning residual contaminant debris remnants. The surface protection of embodiments of the invention is three times stronger than chlorine and 1.5 times stronger than ozone. Embodiments of the invention provide a self-cleaning photo-oxidative surface for as long as the surface remains intact.

Embodiments of compositions, systems, and methods of the invention provide several advantages: broad spectrum protection as a disinfectant, fungicide, and virucide; provide rapid kill times, for example from about 30 seconds to about 5 minutes, from about 30 seconds to about 7 minutes, or less than 2 minutes, less than 5 minutes, less than 7 minutes, or less than 10 minutes; provide residual protection, for example for up to about 24 hours, up to about 48 hours, up to about 1 week, up to about 1 month, up to about 9 weeks, up to about 3 months, or up to about 6 months; are effective against resistant bacteria, such as MRSA and VRE, have the lowest EPA toxicity rating available, and can be used in diverse environments including restaurants, homes, medical facilities, institutions, daycare facilities, and children's play areas, as well as on children's toys.

A further advantage is that embodiments of compositions, systems, and methods of the invention do not leave a residue on the surface to which it is applied, such as a sticky residue. Moreover, embodiments of the invention are safe, provide no to low odor, and dry within five minutes of application allowing for immediate re-entry of personnel to the location of application.

In some embodiments, self-cleaning compositions of the invention may include the constituents in the weight percent of the total weight of the formulation as set forth in Table 1. In some embodiments set forth in Table 1 that include both citric acid and silver, the citric acid and silver may be present in a chelated form (e.g., silver dihydrogen citrate).

TABLE 1

| | Metal Oxide (e.g. | Second Metal | Acid (e.g. Citric | Metal ion (e.g. |
|---|---|---|---|---|
| | TiO₂) | Oxide (e.g. SiO₂) | Acid) | Silver) |
| Formulation 1 | about <1% | about <4% | about 0% | about 0% |
| Formulation 2 | about <1% | about 0% | about 0% | about <0.1% |
| Formulation 3 | >0.375% | <0.005% | <4.5% | <0.005% |
| Formulation 4 | about 0.03% to | about 0.01% to | about 4.7% to | about 0.001% to |
| | about 0.05% | about 0.03% | about 4.9% | about 0.01% |
| Formulation 5 | about 0.01% to | about 0.005% to | about 4% to | about 0.001% to |
| | about 0.1% | about 0.1% | about 6% | about 0.01% |
| Formulation 6 | about 0.01% to | about 0.001% to | about 4% to | about 0.001% to |
| | about 0.1% | about 0.1% | about 6% | about 0.02% |
| Formulation 8 | about 0.01% to | about 0.001% to | about 1% to | about 0.001% to |
| | about 1% | about 1% | about 10% | about 0.1% |
| Formulation 9 | about 0.01% to | about 0.001% to | about 0.1% to | about 0.001% to |
| | about 10% | about 10% | about 10% | about 1% |
| Formulation 10 | about 0.01% to | about 0.001% to | about 0.1% to | about 0.001% to |
| | about 25% | about 25% | about 25% | about 5% |
| Formulation 11 | about 0.01% to | about 0.001% to | about 0.1% to | about 0.001% to |
| | about 50% | about 50% | about 50% | about 10% |
| Formulation 12 | about 0.01% to | about 0.001% to | about 0.1% to | about 0.001% to |
| | about 75% | about 75% | about 75% | about 25% |
| Formulation 13 | about 0.01% to | about 0.001% to | about 0.1% to | about 0.001% to |
| | about 99% | about 99% | about 99% | about 99% |
| Formulation 14 | about 0.03% to | about 0% | about 0% | about 0% |
| | about 0.05% | | | |
| Formulation 15 | about 0.01% to | about 0% | about 0% | about 0% |
| | about 0.1% | | | |
| Formulation 16 | about 0.03% to | about 0.01% to | about 0% | about 0% |
| | about 0.05% | about 0.03% | | |
| Formulation 17 | about 0.01% to | about 0.005% to | about 0% | about 0% |
| | about 0.1% | about 0.1% | | |
| Formulation 18 | about 0.03% to | about 0.01% to | about 4.7% to | about 0% |
| | about 0.05% | about 0.03% | about 4.9% | |
| Formulation 19 | about 0.01% to | about 0.005% to | about 4% to | about 0% |
| | about 0.1% | about 0.1% | about 6% | |
| Formulation 20 | about 0.01% to | about 0.005% to | about 1% to | about 0% |
| | about 0.1% | about 0.1% | about 10% | |
| Formulation 21 | about 0.01% to | about 0.005% to | about 1% to | about 0.001% to |
| | about 0.1% | about 0.1% | about 10% | about 0.01% |
| Formulation 22 | about 0% | about 0% | about 1% to | about 0.001% to |
| | | | about 10% | about 0.01% |
| Formulation 23 | about 0% | about 0% | about 1% to | about 0.001% to |
| | | | about 10% | about 0.1% |
| Formulation 24 | about 0.03% to | about 0% | about 4% to | about 0% |
| | about 0.05% | | about 6% | |
| Formulation 25 | about 0.01% to | about 0% | about 1% to | about 0% |
| | about 0.1% | | about 10% | |

In some embodiments, self-cleaning compositions of the invention have a pH of from about 6.5 to about 7.5, from about 6 to about 8, about 5, about 5.5, about 6, about 6.5, about 7, about 7.5, less than 8, less than 7.5, less than 7, greater than 6, greater than 6.5, or greater than 7.

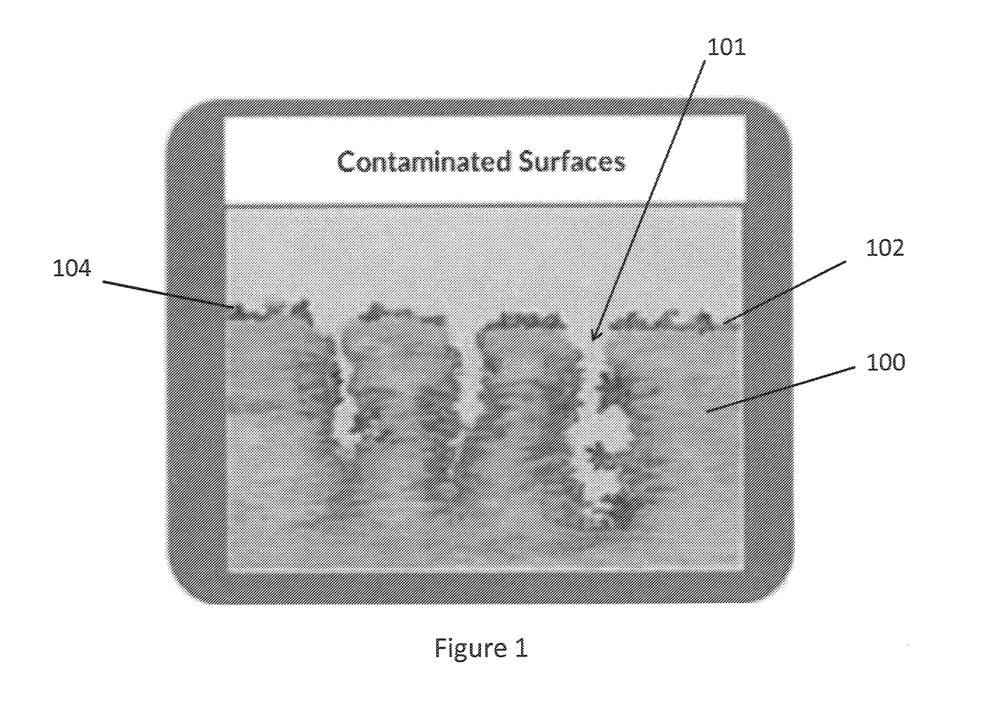

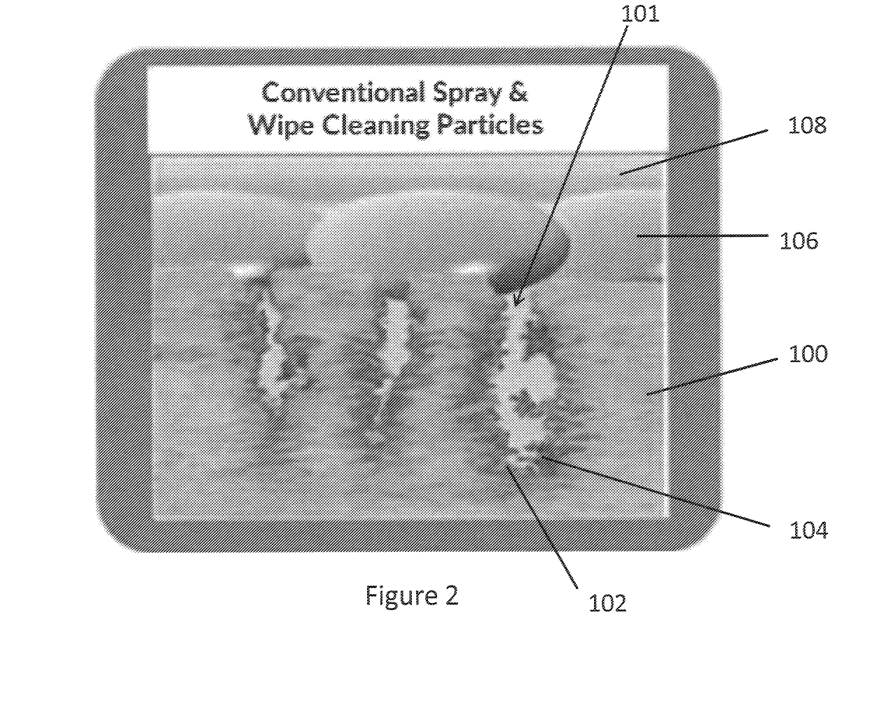

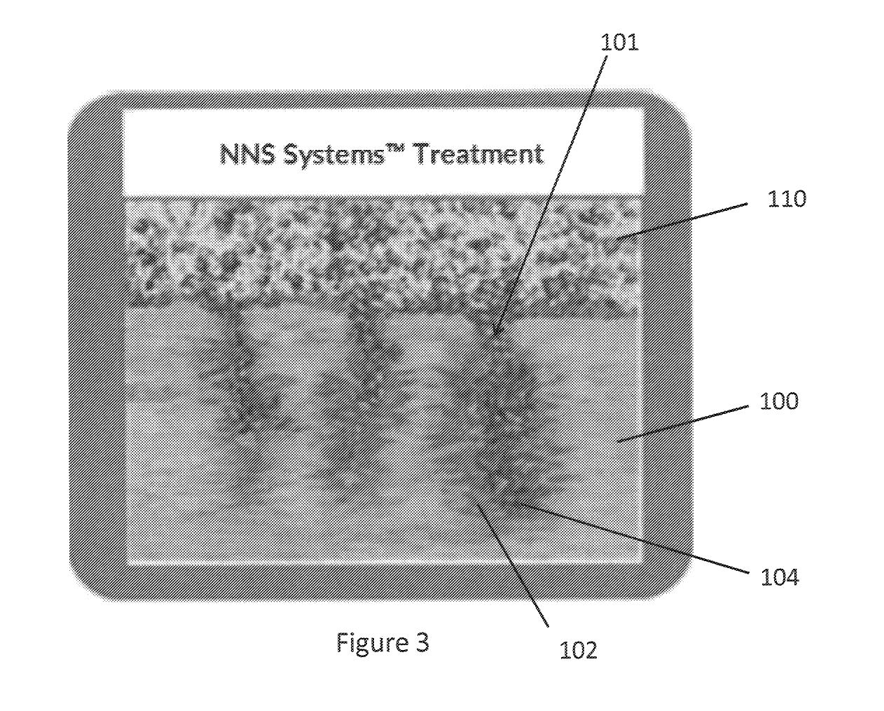

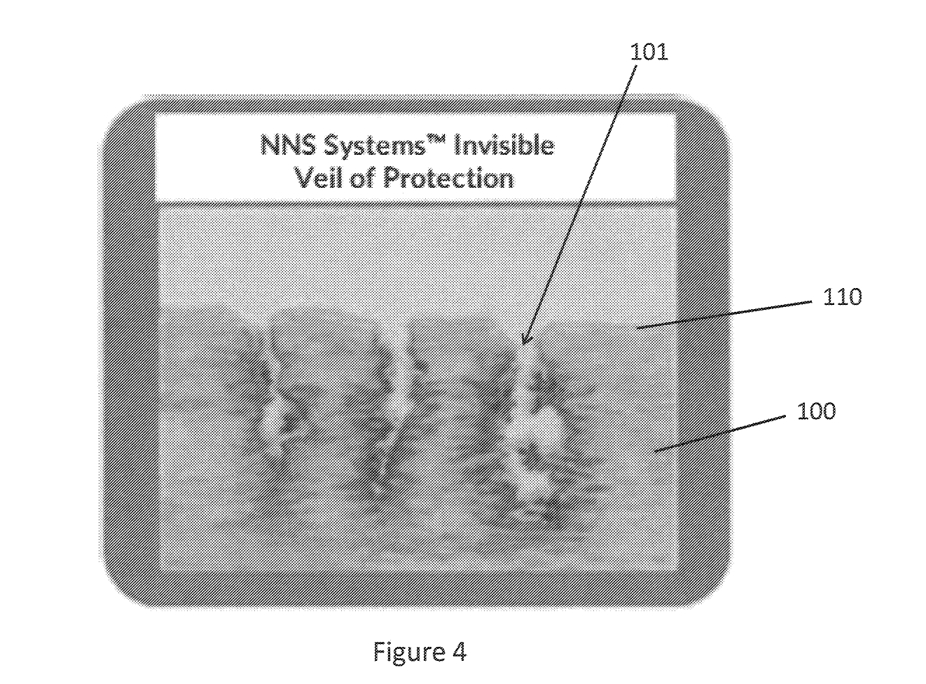

Referring to the drawings in detail, wherein like reference numerals indicate like elements throughout, there is shown in FIGS. 1-4 a surface, generally designated 100, with crevices 101. There is shown in FIGS. 1-3 bacteria, generally designated 102 and a virus, generally designated 104. FIG. 1 shows a surface 100 and crevices 101 contaminated with bacteria 102 and virus 104. FIG. 2 shows surface 100 and crevices 101 contaminated with bacteria 102 and virus 104 being cleaned with a conventional spray composition 106 and wiped with wipe 108. Notably, the conventional spray composition 106 and wipe 108 do not penetrate pores or crevices 101 and do not kill or reduce bacteria 102 or virus 104. FIG. 3 shows surface 100 and crevices 101 and a self-cleaning composition 110 in accordance with an exemplary embodiment of the present invention. Notably, the self-cleaning composition of the invention is able to penetrate pores or crevices 101 and reach bacteria 102 and virus 104, killing or reducing their presence on the surface 100. FIG. 4 shows surface 100 after treatment with a self-cleaning composition 110 in accordance with an exemplary embodiment of the present invention. After treatment, self-cleaning composition 110 in accordance with an exemplary embodiment of the present invention remains on the surface 110, providing continued protection, or an invisible veil of protection, against bacteria, viruses, fungi and/or other microbes.

Metal Oxide Particles

In some embodiments, a self-cleaning composition includes photocatalytic particles. In some embodiments photocatalytic particles may be a metal oxide. In certain embodiments photocatalytic particles may be a transition metal oxide or a Group 4B metal oxide. In certain embodiments, a self-cleaning composition includes titanium dioxide (TiO₂). In some embodiments a self-cleaning composition includes two or more different metal oxides. In a certain embodiments, a self-cleaning composition includes titanium dioxide and a different metal oxide. Suitable optional metal oxides for use alone or in combination with a first metal oxide (e.g., titanium dioxide) include ZrO₂, WO₃, SnO₂, ZnO, Al₂O₃, Au₂O₃, Au₂O, Cu₂O, CuO, and SiO₂.

In some embodiments, a first metal oxide (e.g. titanium dioxide) may have an average particle size of about 6 nm to about 8 nm, about 5 nm to about 9 nm, about 4 nm to about 10 nm, about 3 nm to about 11 nm, about 2 nm to about 12 nm, about 1 nm to about 13 nm, about 1 nm to about 100 nm, about 1 nm to about 50 nm, about 1 nm to about 20 nm, about 2 nm to about 20 nm, about 2 nm to about 10 nm, about 4 nm to about 8 nm, or about 6 nm to about 10 nm.

In some embodiments, a first metal oxide (e.g. titanium dioxide) may have an average particle size of about 1 nm, about 2 nm, about 3 nm, about 4 nm, about 5 nm, about 6 nm, about 7 nm, about 8 nm, about 9 nm, about 10 nm, about 11 nm, about 12 nm, about 13 nm, about 14 nm, or about 15 nm.

In some embodiments, a first metal oxide (e.g. titanium dioxide) may have an average particle size of less than 8 nm, 9 nm, 10 nm, 11 nm, 12 nm, 13 nm, 14 nm, 15 nm, 20 nm, 25 nm, 50 nm, 75 nm, or 100 nm.

In some embodiments, a first metal oxide (e.g. titanium dioxide) may have an average particle size of greater than 1 nm, 2 nm, 3 nm, 4 nm, 5 nm, 6 nm, 7 nm, or 8 nm.

In some embodiments, a self-cleaning composition includes less than 1% by weight first metal oxide (e.g. titanium dioxide) of the total weight of the self-cleaning composition.

In some embodiments a self-cleaning composition includes from about 0.04% to about 0.045%, from about 0.035% to about 0.05%, from about 0.03% to about 0.05%, from about 0.02% to about 0.06%, from about 0.01% to about 0.07%, from about 0.01% to about 0.1%, from about 0.01% to about 1%, from about 0.1% to about 1%, from about 0.01% to about 10%, from about 0.001% to about 0.01%, from about 0.001% to about 1%, from about 0.001% to about 2%, from about 0.001% to about 3%, from about 0.001% to about 4%, from about 0.001% to about 5%, from about 0.001% to about 6%, from about 0.001% to about 7%, from about 0.001% to about 8%, from about 0.001% to about 9%, from about 0.001% to about 10%, from about 0.001% to about 15%, from about 0.001% to about 20%, from about 0.001% to about 25%, from about 0.001% to about 30%, from about 0.001% to about 35%, from about 0.001% to about 40%, from about 0.001% to about 45%, from about 0.001% to about 50%, from about 0.001% to about 55%, from about 0.001% to about 60%, from about 0.001% to about 65%, from about 0.001% to about 70%, from about 0.001% to about 75%, from about 0.001% to about 80%, from about 0.001% to about 85%, from about 0.001% to about 90%, from about 0.001% to about 95%, from about 0.001% to about 99%, from about 0.01% to about 0.02%, from about 0.01% to about 0.03%, from about 0.01% to about 0.04%, from about 0.01% to about 0.05%, from about 0.01% to about 0.06%, from about 0.01% to about 0.07%, from about 0.01% to about 0.08%, from about 0.01% to about 0.09%, from about 0.01% to about 0.1%, from about 0.01% to about 0.2%, from about 0.01% to about 0.3%, from about 0.01% to about 0.4%, from about 0.01% to about 0.5%, from about 0.01% to about 0.6%, from about 0.01% to about 0.7%, from about 0.01% to about 0.8%, from about 0.01% to about 0.9%, from about 0.01% to about 1%, from about 0.01% to about 2%, from about 0.01% to about 3%, from about 0.01% to about 4%, from about 0.01% to about 5%, from about 0.01% to about 6%, from about 0.01% to about 7%, from about 0.01% to about 8%, from about 0.01% to about 9%, from about 0.01% to about 10%, from about 0.01% to about 15%, from about 0.01% to about 20%, from about 0.01% to about 25%, from about 0.01% to about 30%, from about 0.01% to about 35%, from about 0.01% to about 40%, from about 0.01% to about 45%, from about 0.01% to about 50%, from about 0.01% to about 55%, from about 0.01% to about 60%, from about 0.01% to about 65%, from about 0.01% to about 70%, from about 0.01% to about 75%, from about 0.01% to about 80%, from about 0.01% to about 85%, from about 0.01% to about 90%, from about 0.01% to about 95%, from about 0.01% to about 100%, from about 0.1% to about 1%, from about 0.1% to about 2%, from about 0.1% to about 3%, from about 0.1% to about 4%, from about 0.1% to about 5%, from about 0.1% to about 6%, from about 0.1% to about 7%, from about 0.1% to about 8%, from about 0.1% to about 9%, from about 0.1% to about 10%, from about 0.1% to about 15%, from about 0.1% to about 20%, from about 0.1% to about 25%, from about 0.1% to about 30%, from about 0.1% to about 35%, from about 0.1% to about 40%, from about 0.1% to about 45%, from about 0.1% to about 50%, from about 0.1% to about 55%, from about 0.1% to about 60%, from about 0.1% to about 65%, from about 0.1% to about 70%, from about 0.1% to about 75%, from about 0.1% to about 80%, from about 0.1% to about 85%, from about 0.1% to about 90%, from about 0.1% to about 95%, from about 0.1% to about 100%, from about 0.02% to about 0.05%, from about 0.025% to about 0.055%, from about 0.03% to about 0.06%, or from about 0.35% to about 0.65% by weight first metal oxide (e.g. titanium dioxide) of the total weight of the self-cleaning composition.

In some embodiments a self-cleaning composition includes about 0.001%, about 0.005%, about 0.01%, about 0.015%, about 0.02%, about 0.025%, about 0.03, about 0.035%, about 0.036%, about 0.037%, about 0.038%, about 0.039%, about 0.04%, about 0.041%, about 0.042%, about 0.043%, about 0.044%, about 0.045%, about 0.046%, about 0.047%, about 0.048%, about 0.049%, about 0.05%, about 0.051%, about 0.052%, about 0.053%, about 0.054%, about 0.055%, about 0.06%, about 0.07%, about 0.08%, about 0.09%, about 0.1%, about 0.2%, about 0.3%, about 0.4%, about 0.5%, about 0.6%, about 0.7%, about 0.8%, about 0.9%, about 1%, about 2%, about 3%, about 4%, about 5%, about 6%, about 7%, about 8%, about 9%, about 10%, about 15%, about 20%, about 30%, about 40%, about 50%, about 60%, about 70%, about 80%, about 90%, or about 100% by weight first metal oxide (e.g. titanium dioxide) of the total weight of the self-cleaning composition.

In some embodiments, a self-cleaning composition includes less than 100%, 99%, 90%, 80%, 75%, 70%, 60%, 50%, 40%, 30%, 25%, 20%, 15%, 10%, 9%, 8%, 7%, 6%, 5%, 4%, 3%, 2%, 1%, 0.9%, 0.8%, 0.7%, 0.6%, 0.5%, 0.4%, 0.3%, 0.2%, 0.1%, 0.09%, 0.08%, 0.07%, 0.06%, 0.055%, 0.05%, 0.045%, 0.04%, 0.035%, 0.03% by weight first metal oxide (e.g. titanium dioxide) of the total weight of the self-cleaning composition.

In some embodiments, a self-cleaning composition includes greater than 25%, 20%, 15%, 10%, 9%, 8%, 7%, 6%, 5%, 4%, 3%, 2%, 1%, 0.9%, 0.8%, 0.7%, 0.6%, 0.5%, 0.4%, 0.3%, 0.2%, 0.1%, 0.09%, 0.08%, 0.07%, 0.06%, 0.055%, 0.05%, 0.045%, 0.044%, 0.043%, 0.042%, 0.041%, 0.04%, 0.039%, 0.038%, 0.037%, 0.036%, 0.035%, 0.03%, 0.025%, 0.02%, 0.015%, 0.01%, 0.005%, or 0.001% by weight first metal oxide (e.g. titanium dioxide) of the total weight of the self-cleaning composition.

In some embodiments, a second metal oxide, for use alone or in combination with a first metal oxide, may have an average particle size of about 6 nm to about 8 nm, about 5 nm to about 9 nm, about 4 nm to about 10 nm, about 3 nm to about 11 nm, about 2 nm to about 12 nm, about 1 nm to about 13 nm, about 1 nm to about 100 nm, about 1 nm to about 50 nm, about 1 nm to about 20 nm, about 2 nm to about 20 nm, about 2 nm to about 10 nm, about 4 nm to about 8 nm, or about 6 nm to about 10 nm.

In some embodiments, a second metal oxide, for use alone or in combination with a first metal oxide, may have an average particle size of about 1 nm, about 2 nm, about 3 nm, about 4 nm, about 5 nm, about 6 nm, about 7 nm, about 8 nm, about 9 nm, about 10 nm, about 11 nm, about 12 nm, about 13 nm, about 14 nm, or about 15 nm.

In some embodiments, a second metal oxide, for use alone or in combination with a first metal oxide, may have an average particle size of less than 8 nm, 9 nm, 10 nm, 11 nm, 12 nm, 13 nm, 14 nm, 15 nm, 20 nm, 25 nm, 50 nm, 75 nm, or 100 nm.

In some embodiments, a second metal oxide, for use alone or in combination with a first metal oxide, may have an average particle size of greater than 1 nm, 2 nm, 3 nm, 4 nm, 5 nm, 6 nm, 7 nm, or 8 nm.

In some embodiments a self-cleaning composition includes from about 0.001% to about 1%, from about 0.01% to about 1%, from about 0.01% to about 0.1%, from about 0.001% to about 0.1%, from about 0.001% to about 0.06%, from about 0.001% to about 0.05%, from about 0.001% to about 0.04%, from about 0.005% to about 0.035%, from about 0.01% to about 0.03%, from about 0.015% to about 0.025%, from about 0.005% to about 0.025%, from about 0.015% to about 0.035%, from about 0.02% to about 0.04%, from about 0.001% to about 0.01%, from about 0.001% to about 1%, from about 0.001% to about 2%, from about 0.001% to about 3%, from about 0.001% to about 4%, from about 0.001% to about 5%, from about 0.001% to about 6%, from about 0.001% to about 7%, from about 0.001% to about 8%, from about 0.001% to about 9%, from about 0.001% to about 10%, from about 0.001% to about 15%, from about 0.001% to about 20%, from about 0.001% to about 25%, from about 0.001% to about 30%, from about 0.001% to about 35%, from about 0.001% to about 40%, from about 0.001% to about 45%, from about 0.001% to about 50%, from about 0.001% to about 55%, from about 0.001% to about 60%, from about 0.001% to about 65%, from about 0.001% to about 70%, from about 0.001% to about 75%, from about 0.001% to about 80%, from about 0.001% to about 85%, from about 0.001% to about 90%, from about 0.001% to about 95%, from about 0.001% to about 100%, from about 0.01% to about 0.02%, from about 0.01% to about 0.03%, from about 0.01% to about 0.04%, from about 0.01% to about 0.05%, from about 0.01% to about 0.06%, from about 0.01% to about 0.07%, from about 0.01% to about 0.08%, from about 0.01% to about 0.09%, from about 0.01% to about 0.1%, from about 0.01% to about 0.2%, from about 0.01% to about 0.3%, from about 0.01% to about 0.4%, from about 0.01% to about 0.5%, from about 0.01% to about 0.6%, from about 0.01% to about 0.7%, from about 0.01% to about 0.8%, from about 0.01% to about 0.9%, from about 0.01% to about 1%, from about 0.01% to about 2%, from about 0.01% to about 3%, from about 0.01% to about 4%, from about 0.01% to about 5%, from about 0.01% to about 6%, from about 0.01% to about 7%, from about 0.01% to about 8%, from about 0.01% to about 9%, from about 0.01% to about 10%, from about 0.01% to about 15%, from about 0.01% to about 20%, from about 0.01% to about 25%, from about 0.01% to about 30%, from about 0.01% to about 35%, from about 0.01% to about 40%, from about 0.01% to about 45%, from about 0.01% to about 50%, from about 0.01% to about 55%, from about 0.01% to about 60%, from about 0.01% to about 65%, from about 0.01% to about 70%, from about 0.01% to about 75%, from about 0.01% to about 80%, from about 0.01% to about 85%, from about 0.01% to about 90%, from about 0.01% to about 95%, from about 0.01% to about 100%, from about 0.1% to about 1%, from about 0.1% to about 2%, from about 0.1% to about 3%, from about 0.1% to about 4%, from about 0.1% to about 5%, from about 0.1% to about 6%, from about 0.1% to about 7%, from about 0.1% to about 8%, from about 0.1% to about 9%, from about 0.1% to about 10%, from about 0.1% to about 15%, from about 0.1% to about 20%, from about 0.1% to about 25%, from about 0.1% to about 30%, from about 0.1% to about 35%, from about 0.1% to about 40%, from about 0.1% to about 45%, from about 0.1% to about 50%, from about 0.1% to about 55%, from about 0.1% to about 60%, from about 0.1% to about 65%, from about 0.1% to about 70%, from about 0.1% to about 75%, from about 0.1% to about 80%, from about 0.1% to about 85%, from about 0.1% to about 90%, from about 0.1% to about 95%, or from about 0.1% to about 100% by weight second metal oxide of the total weight of the self-cleaning composition.

In some embodiments a self-cleaning composition includes about 0.001%, about 0.005%, about 0.01%, about 0.015%, about 0.016%, about 0.017%, about 0.018%, about 0.019%, about 0.02%, about 0.021%, about 0.022%, about 0.023%, about 0.024%, about 0.025%, about 0.03%, about 0.035%, about 0.036%, about 0.037%, about 0.038%, about 0.039%, about 0.04%, about 0.041%, about 0.042%, about 0.043%, about 0.044%, about 0.045%, about 0.046%, about 0.047%, about 0.048%, about 0.049%, about 0.05%, about 0.051%, about 0.052%, about 0.053%, about 0.054%, about 0.055%, about 0.06%, about 0.07%, about 0.08%, about 0.09%, about 0.1%, about 0.2%, about 0.3%, about 0.4%, about 0.5%, about 0.6%, about 0.7%, about 0.8%, about 0.9%, about 1%, about 2%, about 3%, about 4%, about 5%, about 6%, about 7%, about 8%, about 9%, about 10%, about 15%, about 20%, about 30%, about 40%, about 50%, about 60%, about 70%, about 80%, about 90%, or about 100% by weight second metal oxide of the total weight of the self-cleaning composition.

In some embodiments, a self-cleaning composition includes less than 100%, 99%, 90%, 80%, 75%, 70%, 60%, 50%, 40%, 30%, 25%, 20%, 15%, 10%, 9%, 8%, 7%, 6%, 5%, 4%, 3%, 2%, 1%, 0.9%, 0.8%, 0.7%, 0.6%, 0.5%, 0.4%, 0.3%, 0.2%, 0.1%, 0.09%, 0.08%, 0.07%, 0.06%, 0.055%, 0.05%, 0.045%, 0.04%, 0.035%, 0.03% by weight second metal oxide of the total weight of the self-cleaning composition.

In some embodiments, a self-cleaning composition includes greater than 25%, 20%, 15%, 10%, 9%, 8%, 7%, 6%, 5%, 4%, 3%, 2%, 1%, 0.9%, 0.8%, 0.7%, 0.6%, 0.5%, 0.4%, 0.3%, 0.2%, 1%, 0.9%, 0.8%, 0.7%, 0.6%, 0.5%, 0.4%, 0.3%, 0.2%, 0.1%, 0.09%, 0.08%, 0.07%, 0.06%, 0.055%, 0.05%, 0.045%, 0.044%, 0.043%, 0.042%, 0.041%, 0.04%, 0.039%, 0.038%, 0.037%, 0.036%, 0.035%, 0.03%, 0.02%, 0.01%, 0.005%, or 0.001% by weight second metal oxide of the total weight of the self-cleaning composition.

Every metal oxide average particle size is combinable with each and every weight percent of the metal oxide to form a separate embodiment. Each and every first metal oxide (e.g. titanium dioxide) average particle size is combinable with each and every second metal oxide (e.g. silicon dioxide) particle size to combine a separate embodiment. Each and every first metal oxide (e.g. titanium dioxide) average particle size is combinable with each and every second metal oxide weight percent to form a separate embodiment. Each and every first metal oxide (e.g. titanium dioxide) weight percent is combinable with each and every second metal oxide weight percent to form a separate embodiment. Each and every second metal oxide particle size is combinable with each and every second metal oxide weight percent to form a separate embodiment. In certain embodiments the second metal oxide may be silicon dioxide.

In some embodiments, a self-cleaning composition includes a carrier. In some embodiments a self-cleaning composition includes sufficient carrier to make 100 weight percent. In some embodiments the carrier is water.

Antimicrobial Agent

In some embodiments a self-cleaning composition includes an antimicrobial agent. In some embodiments a method of sanitizing and/or disinfecting a surface includes applying a composition comprising an antimicrobial agent. An antimicrobial agent may be any compound or substance that kills, inhibits, or slows the growth of microorganisms. Suitable antimicrobial agents for use in embodiments of the invention include, but are not limited to, any antimicrobial product registered with the U.S. Environmental Protection Agency (EPA) as a sterilizer.

Suitable antimicrobial agents for use in embodiments of the invention include, but are not limited to, silver dihydrogen citrate (SDC), 2-benzyl-4-chlorophenol, 2-(hydroxymethyl)-2-nitro-1,3-propanediol, 4-tert-amylphenol, alkyl dimethyl benzyl ammonium chloride (60% C14, 30% C16, 5% C18, 5% C12), alkyl dimethyl benzyl ammonium chloride (50% C14, 40% C12, 10% C16), alkyl dimethyl ethylbenzyl ammonium chloride (68% C12, 32% C14), alkyl dimethyl benzyl ammonium chloride (67% C12, 25% C14, 7% C16, 1% C18), citric acid, didecyl dimethyl ammonium chloride, dioctyl dimethyl ammonium chloride, ethyl alcohol, formaldehyde, glutaraldehyde, hydrochloric acid, hydrogen peroxide, o-phenylphenol, o-phenylphenol potassium salt, octanoic acid, octyl decyl dimethyl ammonium chloride, p-tert-amylphenol, potassium salt, peroxyacetic acid, phenol, phosphoric acid, potassium 2-benzyl-4-chlorophenate, potassium peroxymonosulfate, sodium chloride, sodium chlorites, sodium dichloroisocyanurate dihydrate, sodium dichloro-s-triazinetrione, sodium hypochlorite, sodium phenate, iodine, pine oil, triethylene glycol, isopropyl alcohol, alkyl dimethyl ethylbenzyl ammonium chloride (50% C12, 30% C14, 17% C16, 3% C18). alkyl dimethyl ethyl ammonium bromide (90% C14, 5% C16, 5% C12), alkyl dimethyl benzyl ammonium chloride (58% C14, 28% C16, 14% C12), propylene glycol, L-lactic acid, glycolic acid, chlorine dioxide, sodium 2-benzyl-4-chlorophenol, o-phenylphenol, sodium salt, thymol, alkyl dimethyl benzyl ammonium chloride (67% C12, 25% C14, 7% C16, 1% C8, C10, and C18s), N,N-dimetyl-N-(2-(2-(4-(1,1,3,3-tetramethylbutyl)phenoxy)ethoxy)ethyl) benzenemethanaminium chloride, silver, sodium bromide, chloroxylenol, alkyl dimethyl benzyl ammonium chloride (61% C12, 23% C14, 11% C16, 2.5% C18, 2.5% C10, and trace of C8), tributyltin oxide, methyl oxirane, peroxyoctanoic acid, sodium carbonate, sodium hydroxide, nonylphenoxypolyethoxyethanol-iodine complex, poly(iminoimidocarbonyliminoimidocarbonyliminohexamethylene) hydrochloride, tetraacetylethylenediamine, ethaneperoxioic acid, caprylic acid, ethylene oxide, silver peroxide, and combinations of two or more thereof. Some embodiments may include two or more antimicrobial agents.

In some embodiments an antimicrobial agent for use with embodiments of self-cleaning compositions of the invention may be a botanical or essential oil. Suitable essential oils for use in embodiments of self-cleaning compositions of the invention include, but are not limited to, cinnamon oil, clove oil, eucalyptus oil, garlic, oregano oil, lavender oil, leleshwa oil, lemon oil, lemon myrtle oil, mint oil, neem oil, nigella sattiva (black cumin) oil, onion oil, peppermint oil, sandalwood oil, ironwort, tee tree oil, thyme oil, and combinations of two or more thereof.

In some embodiments, an antimicrobial agent for use with embodiments of a self-cleaning composition includes an acid-metal ion complex. In some embodiments the acid-metal ion complex includes a Group D3 (also referred to as Group 11) metal (e.g. silver). In some embodiments, a self-cleaning composition includes silver dihydrogen citrate. Silver dihydrogen citrate includes citric acid and silver ions and is effective against a broad spectrum of microbes.

In some embodiments, an antimicrobial agent (e.g. silver dihydrogen citrate) for use with embodiments of self-cleaning compositions of the invention includes a ratio of acid ions to metal ions of about 2000:1, about 1950:1, about 1900:1, about 1850:1, about 1800:1, about 1750:1, about 1700:1, about 1650:1, about 1600:1, about 1550:1, about 1500:1, about 1450:1, about 1400:1, about 1350:1, about 1300:1, about 1250:1, about 1200:1, about 1150:1, about 1100:1, about 1050:1, about 1000:1, about 990:1, about 980:1, about 970:1, about 960:1, about 950:1, about 940:1, about 930:1, about 920:1, about 910:1, about 900:1, about 850:1, about 800:1, about 750:1, about 700:1, about 650:1, about 600:1, about 550:1, about 500:1, about 450:1, about 400:1, about 350:1, about 300:1, about 250:1, about 200:1, about 150:1, about 100:1, or about 50:1.

In some embodiments an antimicrobial agent for use with embodiments of a self-cleaning composition includes a metal ion (e.g. silver ion) having an average particle size of from about 15 μm to about 25 μm, from about 10 μm to about 30 μm, from about 5 μm to about 35 μm, from about 1 μm to about 40 μm, from about 1 μm to about 50 μm, from about 1 μm to about 75 μm, from about 1 μm to about 100 μm, from about 1 μm to about 25 μm, from about 1 μm to about 30 μm, from about 15 μm to about 40 μm, or from about 10 μm to about 40 μm.

In some embodiments an antimicrobial agent for use with embodiments of a self-cleaning composition includes a metal ion (e.g. silver ion) having an average particle size of about 1 μm, about 5 μm, about 10 μm, about 15 μm, about 16 μm, about 17 μm, about 18 μm, about 19 μm, about 20 μm, about 21 μm, about 22 μm, about 23 μm, about 24 μm, about 25 μm, about 30 μm, about 35 μm, about 40 μm, or about 50 μm.

In some embodiments an antimicrobial agent for use with embodiments of a self-cleaning composition includes a metal ion (e.g. silver ion) having an average particle size of greater than about 1 μm, about 5 μm, about 10 μm, about 15 μm, about 16 μm, about 17 μm, about 18 μm, about 19 μm, about 20 μm, about 21 μm, about 22 μm, about 23 μm, about 24 μm, or about 25 μm.

In some embodiments, an antimicrobial agent for use with embodiments of a self-cleaning composition includes a metal ion (e.g. silver ion) having an average particle size of less than about 15 μm, about 16 μm, about 17 μm, about 18 μm, about 19 μm, about 20 μm, about 21 μm, about 22 μm, about 23 μm, about 24 μm, about 25 μm, about 30 μm, about 35 μm, about 40 μm, or about 50 μm.

In some embodiments a self-cleaning composition includes from about 1% to about 10%, from about 2% to about 9% from about 3% to about 8%, from about 3% to about 6%, from about 1% to about 4%, from about 2% to about 5%, from about 3% to about 6%, from about 4% to about 7%, from about 5% to about 8%, from about 6% to about 9%, from about 0.1% to about 2%, from about 0.1% to about 3%, from about 0.1% to about 4%, from about 0.1% to about 5%, from about 0.1% to about 6%, from about 0.1% to about 7%, from about 0.1% to about 8%, from about 0.1% to about 9%, from about 0.1% to about 10%, from about 0.1% to about 15%, from about 0.1% to about 20%, from about 0.1% to about 25%, from about 0.1% to about 30%, from about 0.1% to about 35%, from about 0.1% to about 40%, from about 0.1% to about 45%, from about 0.1% to about 50%, from about 0.1% to about 55%, from about 0.1% to about 60%, from about 0.1% to about 65%, from about 0.1% to about 70%, from about 0.1% to about 75%, from about 0.1% to about 80%, from about 0.1% to about 85%, from about 0.1% to about 90%, from about 0.1% to about 95%, from about 0.1% to about 100%, from about 1% to about 2%, from about 1% to about 3%, from about 1% to about 4%, from about 1% to about 5%, from about 1% to about 6%, from about 1% to about 7%, from about 1% to about 8%, from about 1% to about 9%, from about 1% to about 10%, from about 1% to about 15%, from about 1% to about 20%, from about 1% to about 25%, from about 1% to about 30%, from about 1% to about 35%, from about 1% to about 40%, from about 1% to about 45%, from about 1% to about 50%, from about 1% to about 55%, from about 1% to about 60%, from about 1% to about 65%, from about 1% to about 70%, from about 1% to about 75%, from about 1% to about 80%, from about 1% to about 85%, from about 1% to about 90%, from about 1% to about 95%, or from about 1% to about 100%, by weight antimicrobial agent of the total weight of the self-cleaning composition.

In some embodiments a self-cleaning composition includes about 0.01%, about 0.1%, about 0.5%, 1%, about 2%, about 2.5%, about 3%, about 3.5%, about 4%, about 4.1%, about 4.2%, about 4.3%, about 4.4%, about 4.5%, about 4.6%, about 4.7%, about 4.8%, about 4.9%, about 5%, about 5.1%, about 5.2%, about 5.3%, about 5.4%, about 5.5%, about 6%, about 7%, about 8%, about 9%, about 10%, about 11%, about 12%, about 13%, about 14%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 100% by weight antimicrobial agent of the total weight of the self-cleaning composition.

In some embodiments a self-cleaning composition includes at least 1%, 2%, 2.5%, 3%, 3.5%, 4%, 4.1%, 4.2%, 4.3%, 4.4%, 4.5%, 4.6%, 4.7%, 4.8%, 4.9%, 5%, 5.1%, 5.2%, 5.3%, 5.4%, 5.5%, 6%, 7%, 8%, 9%, 10%, 15%, 20%, or 25% by weight antimicrobial agent.

In some embodiments a self-cleaning composition includes less than 100%, 95%, 90%, 85%, 80%, 75%, 70%, 65%, 60%, 55%, 50%, 45%, 40%, 35%, 30%, 25%, 20%, 15%, 10%, 9%, 8%, 7%, 6%, 5.5%, 5.4%, 5.3%, 5.2%, 5.1%, 5%, 4.9%, 4.8%, 4.7%, 4.6%, 4.5%, 4.4%, 4.3%, 4.2%, 4.1%, 4%, 3.5%, 3%, or 2.5% by weight antimicrobial agent.

In some embodiments a self-cleaning composition includes two or more antimicrobial agents. Every antimicrobial agent described herein can be combined with any other antimicrobial agent described herein and each such combination forms a separate embodiment of the invention.

Other Additives

In some embodiments, a self-cleaning composition optionally includes one or more additives. In some embodiments a self-cleaning composition includes a surfactant. In some embodiments a self-cleaning composition includes a dispersant.

In some embodiments a self-cleaning composition includes a surfactant. Suitable surfactants for use in embodiments of the invention include, but are not limited to, ammonium lauryl sulfate, sodium lauryl sulfate (also referred to as sodium dodecyl sulfate or SDS), sodium laureth sulfate (also referred to as sodium lauryl ether sulfate or SLES), sodium myreth sulfate, dioctyl sodium sulfosuccinate, perfluorooctanesulfonate (PFOS), perfluorobutanesulfonate, linear alkylbenzene sulfonates (LABs), sodium stearate, sodium lauroyl sarcosinate, perfluorononanoate, perfluorooctanoate (PFOA or PFO), octenidine dihydrochloride, cetyl trimethylammonium bromide (also referred to as CTAB or hexadecyl trimethyl ammonium bromide), cetyl trimethylammonium chloride (CTAC), cetylpyridinium chloride (CPC), benzalkonium chloride (BAC), benzethonium chloride (BZT), 5-bromo-5-nitro-1,3-dioxane, dimethyldioctadecylammonium chloride, cetrimonium bromide, dioctadecyldimethylammonium bromide (DODAB), 3-[(3-cholamidopropyl)dimethylammonio]-1-propanesulfonate (also referred to as CHAPS), cocamidopropyl hydroxysultaine, cocamidopropyl betaine, lecithin, Polyoxyethylene glycol alkyl ethers (Brij): CH3-(CH2)10-16-(O—C2H4)1-25-OH: Octaethylene glycol monododecyl ether, pentaethylene glycol monododecyl ether, polyoxypropylene glycol alkyl ethers, glucoside alkyl ethers, decyl glucoside, lauryl glucoside, octyl glucoside, polyoxyethylene glycol octylphenol ethers, Triton X-100, polyoxyethylene glycol alkylphenol ethers, nonoxynol-9, glycerol alkyl esters, glyceryl laurate, polyoxyethylene glycol sorbitan alkyl esters, polysorbate, sorbitan alkyl esters, spans, cocamide MEA, cocamide DEA, dodecyldimethylamine oxide, block copolymers of polyethylene glycol and polypropylene glycol, poloxamers, and polyethoxylated tallow amine (POEA).

In some embodiments a self-cleaning composition includes about 0.0008%, about 0.0009%, about 0.001%, about 0.002%, about 0.003%, about 0.004%, about 0.005%, about 0.006%, about 0.007%, about 0.008%, about 0.009%, about 0.01%, about 0.05%, about 0.1%, about 1%, about 2%, about 3%, about 4%, about 5%, about 6%, about 7%, about 8%, about 9%, about 10%, about 15%, about 20%, about 25%, about 30%, about 35%, about 40%, about 45%, or about 50% by weight surfactant of the total weight of the self-cleaning composition.

In some embodiments a self-cleaning composition includes from about 0.001% to about 0.01%, from about 0.001% to about 0.009%, from about 0.001% to about 0.008%, from about 0.001% to about 0.007%, from about 0.001% to about 0.006%, from about 0.001% to about 0.005%, from about 0.001% to about 0.004%, from about 0.001% to about 0.003%, from about 0.002% to about 0.004%, from about 0.001% to about 0.1%, from about 0.001% to about 0.5%, from about 0.001% to about 1%, from about 0.001% to about 2%, from about 0.001% to about 5%, from about 0.001% to about 10%, from about 0.001% to about 15%, from about 0.001% to about 20%, from about 0.001% to about 25%, from about 0.001% to about 30%, from about 0.001% to about 35%, from about 0.001% to about 40%, from about 0.001% to about 45%, or from about 0.001% to about 50% by weight surfactant of the total weight of the self-cleaning composition.

In some embodiments a self-cleaning composition includes greater than about 0.0008%, about 0.0009%, about 0.001%, about 0.002%, about 0.003%, about 0.004%, about 0.005%, about 0.006%, about 0.007%, about 0.008%, 0.009%, about 0.01%, about 0.02%, about 0.03%, about 0.04%, about 0.05%, about 0.06%, about 007%, about 0.08%, about 0.09%, about 0.1%, about 1%, about 5%, about 10%, about 15%, about 20%, about 25%, about 30%, about 35%, about 40%, about 45%, or about 50% by weight surfactant of the total weight of the self-cleaning composition.

In some embodiments a self-cleaning composition includes less than about 10%, about 9%, about 8%, about 7%, about 6%, about 5%, about 4%, about 3%, about 2%, about 1%, about 0.9%, about 0.8%, about 0.7%, about 0.6%, about 0.5%, about 0.4%, about 0.3%, about 0.2%, about 0.1%, about 0.09%, about 0.08%, about 0.07%, about 0.06%, about 0.05%, about 0.04%, about 0.03%, about 0.02%, about 0.001%, about 0.002%, about 0.003%, about 0.004%, about 0.005%, about 0.006%, about 0.007%, about 0.008%, about 0.009%, about 0.01% by weight surfactant of the total weight of the self-cleaning composition.

In some embodiments a self-cleaning composition includes a dispersant. A dispersing agents should be capable, when mixed with a metal oxide (e.g. titanium dioxide), of forming a solution or dispersion. Preferably, the dispersant will form a homogeneous solution when combined with a metal oxide (e.g. titanium dioxide). Suitable dispersants for use in embodiments of the invention include, but are not limited to, various alcohols containing 1 to 6 carbon atoms, methanol, ethanol, isopropanol, water, glycols, propylene glycol, hexylene glycol and glycol ethers.

In some embodiments a self-cleaning composition includes about 100%, about 98%, about 97%, about 96%, about 95%, about 94%, about 93%, about 92%, about 91%, about 90%, about 89%, about 88%, about 87%, about 86%, about 85%, about 80%, about 75%, about 70%, about 65%, about 60%, about 55%, about 50%, about 45%, about 40% about 35%, about 30%, about 25%, about 20%, about 15%, about 10%, about 5%, or about 1% by weight dispersant of the total weight of the self-cleaning composition.

In some embodiments a self-cleaning composition includes from about 80% to about 90%, from about 85% to about 95%, from about 88% to about 98%, from about 80% to about 100%, from about 85% to about 100%, from about 90% to about 100%, from about 95% to about 100%, from about 96% to about 100%, from about 95% to about 98%, from about 96% to about 98%, from about 100% to about 75%, from about 100% to about 70%, from about 100% to about 65%, from about 100% to about 60%, from about 100% to about 55%, from about 100% to about 50%, from about 100% to about 45%, from about 100% to about 40%, from about 100% to about 35%, from about 100% to about 30%, from about 100% to about 25%, from about 100%, to about 20%, from about 100% to about 20%, from about 100% to about 15%, from about 100% to about 10%, from about 100% to about 5%, or from about 100% to about 1% by weight dispersant of total weight of the self-cleaning composition.

In some embodiments a self-cleaning composition includes greater than about 98%, about 97%, about 96%, about 95%, about 94%, about 93%, about 92%, about 91%, about 90%, about 89%, about 88%, about 87%, about 86%, about 85%, about 80%, about 75%, about 70%, about 65%, about 60%, about 55%, about 50%, about 45%, about 40%, about 35%, about 30%, about 25%, about 20%, about 15%, about 10%, about 5%, or about 1%, by weight dispersant of the total weight of the self-cleaning composition.

In some embodiments a self-cleaning composition includes less than about 100%, about 99%, about 98%, about 97%, about 96%, about 95%, about 94%, about 93%, about 92%, about 91%, about 90%, about 89%, about 88%, about 8′7%, about 86%, about 85%, about 80%, about 75%, about 70%, about 65%, about 60%, about 55%, about 50%, about 45%, about 40%, about 35%, about 30%, about 25%, about 20%, about 15%, about 10%, or about 5% by weight dispersant of the total weight of the self-cleaning composition.

In some embodiments, a self-cleaning composition includes a carrier. In some embodiments a self-cleaning composition includes sufficient carrier to make 100 weight percent. In some embodiments the carrier is water.

System

In some embodiments, a system for providing a self-cleaning coating includes a self-cleaning composition that includes a first metal oxide (e.g. titanium dioxide) and a second metal oxide (e.g. silicon dioxide); and a second composition that includes an antimicrobial agent. In some embodiments the second composition is maintained separately from the first composition until application. In some embodiments the second composition is maintained separately from the first composition until being ejected simultaneously from a sprayer, such as an electrostatic sprayer. Metal oxides suitable for use in embodiments of the invention are described above. Antimicrobial agents suitable for use in embodiments of the invention are described above. In some embodiments a second composition includes silver dihydrogen citrate.

In some embodiments, a second composition that includes an antimicrobial agent further includes a solvent and/or a carrier. In some embodiments a second composition includes sufficient solvent and/or carrier to make 100 weight percent. In some embodiments the solvent and/or carrier is water.

Methods of Application

In some embodiments a method of sanitizing and/or disinfecting a surface includes applying to the surface a self-cleaning composition including a first metal oxide (e.g. titanium dioxide) and a second metal oxide (e.g. silicon dioxide). Self-cleaning compositions useful in methods of sanitizing and/or disinfecting a surface are described in detail above. In some embodiments the self-cleaning composition can be applied by painting, rubbing, wiping, spraying, or any other means apparent to a person of ordinary skill in the art. In certain embodiments a method of sanitizing and/or disinfecting a surface includes electrostatic spraying.

In some embodiments, a method of sanitizing and/or disinfecting a surface includes applying to the surface a self-cleaning composition that is about 10%, about 20%, about 30%, about 40%, about 50%, about 60%, about 70%, about 75%, about 80%, about 85%, about 90%, about 95%, about 99%, or about 100% ionized. In some embodiments where an antimicrobial agent is applied separately, the antimicrobial agent is about 10%, about 20%, about 30%, about 40%, about 50%, about 60%, about 70%, about 75%, about 80%, about 85%, about 90%, about 95%, about 99%, or about 100% ionized.

In some embodiments, a method of sanitizing and/or disinfecting a surface includes applying to the surface a self-cleaning composition that is from about 10% to about 100%, from about 20%, to about 100%, from about 30% to about 100%, from about 40% to about 100%, from about 50% to about 100%, from about 60% to about 100%, from about 70% to about 100%, from about 75% to about 100%, from about 80% to about 100%, from about 85% to about 100%, from about 80% to about 90%, from about 90% to about 100%, from about 95% to about 100%, from about 0% to about 20%, from about 20% to about 50%, or from about 50% to about 70% ionized. In some embodiments where an antimicrobial agent is applied separately, the antimicrobial agent is from about 10% to about 100%, from about 20%, to about 100%, from about 30% to about 100%, from about 40% to about 100%, from about 50% to about 100%, from about 60% to about 100%, from about 70% to about 100%, from about 75% to about 100%, from about 80% to about 100%, from about 85% to about 100%, from about 80% to about 90%, from about 90% to about 100%, from about 0% to about 20%, from about 20% to about 50%, or from about 50% to about 70% or from about 95% to about 100% ionized.

In some embodiments, a method of sanitizing and/or disinfecting a surface includes applying to the surface a self-cleaning composition that is greater than 10%, greater than 20%, greater than 30%, greater than 40%, greater than 50%, greater than 60%, greater than 70%, greater than 75%, greater than 80%, greater than 85%, greater than 90%, or greater than 95% ionized. In some embodiments where an antimicrobial agent is applied separately, the antimicrobial agent is greater than 10%, greater than 20%, greater than 30%, greater than 40%, greater than 50%, greater than 60%, greater than 70%, greater than 75%, greater than 80%, greater than 85%, greater than 90%, or greater than 95% ionized.

In some embodiments a method of sanitizing and/or disinfecting a surface, the self-cleaning composition to be applied includes an antimicrobial agent applied simultaneously with the first and/or second metal oxide. In other embodiments a method of sanitizing and/or disinfecting a surface includes applying to the surface a self-cleaning composition comprising a first metal oxide (e.g. titanium dioxide) and optionally a second metal oxide (e.g. silicon dioxide) and applying a second composition that includes an antimicrobial agent at a separate time (e.g. an earlier time or a later time). In some embodiments the composition that includes a metal oxide is maintained separately from a composition that includes an antimicrobial agent but the compositions are ejected from simultaneously from a single sprayer, which may be an electrostatic sprayer. In some embodiments the composition that includes a metal oxide is maintained separately from a composition that includes an antimicrobial agent and the compositions are applied simultaneously through separate sprayers, each of which may be an electrostatic sprayer.

In some embodiments a method of santizing a surface includes applying a composition comprising a metal oxide and applying a composition comprising an antimicrobial agent. In some embodiments the composition that includes the metal oxide is applied before the composition that includes the antimicrobial agent, in other embodiments the order is reversed, while in still other embodiments the composition that includes the metal oxide is applied simultaneously as the composition that includes the antimicrobial agent. In some embodiments a method of santizing a surface includes applying a composition comprising a metal oxide, applying a second metal oxide, and applying a composition comprising an antimicrobial agent. In some embodiments the metal oxide and the second metal oxide are included in the same composition and are applied simultaneously. In other embodiments the composition that includes the metal oxide is maintained separately from the second metal oxide and they are applied sequentially (e.g. the metal oxide is applied before the second metal oxide or the reverse). In some embodiments the first metal oxide and the second metal oxide are both applied before the antimicrobial agent. In some embodiments the first metal oxide is applied before the antimicrobial agent and the second metal oxide is applied after the antimicrobial agent. In still other embodiments the antimicrobial agent is applied to the surface, followed by application of the first metal oxide and the second metal oxide, which may be applied simultaneously or sequentially. In some embodiments a composition that includes a second antimicrobial agent is applied to the surface. A composition that includes a second antimicrobial agent may be applied after application of a first antimicrobial agent, or simultaneously with the first antimicrobial agent. The order of steps described is exemplary and not limiting; the first metal oxide, second metal oxide, and antimicrobial agent may be applied in any order and in any combination.

In some embodiments, about 0 seconds, about 15 seconds, about 30 seconds, about 1 minute, about 2 minutes, about 3 minutes, about 4 minutes, about 5 minutes, about 10 minutes, or from about 0 seconds to about 24 hours, from about 0 seconds to about 12 hours, from about 0 seconds to about 0 seconds to about 8 hours, from about 0 seconds to about 4 hours, from about 0 seconds to about 1 hour, from about 0 seconds to about 30 minutes, from about 0 seconds to about 15 minutes, from about 0 seconds to about 10 minutes, from about 0 seconds to about 5 minutes, from about 0 seconds to about 1 minutes, from about 0 seconds to about 30 seconds, from about 30 seconds to about 5 minutes, less than 24 hours, less than 12 hours, less than 8 hours, less than 4 hours, less than 1 hours, less than 30 minutes, less than 15 minutes, less than 10 minutes, less than 5 minutes, less than 1 minutes, or less than 30 seconds may elapse between application of a composition that includes a metal oxide and application of a composition that includes an antimicrobial agent.

Systems comprising a self-cleaning composition and a second composition that are useful in methods of sanitizing and/or disinfecting a surface are described in detail above. In some embodiments the composition comprising an antimicrobial agent can be applied by painting, rubbing, wiping, spraying, or any other means apparent to a person of ordinary skill in the art. In certain embodiments a method of sanitizing and/or disinfecting a surface includes electrostatic spraying.

Electrostatic spraying can be performed using commercially available electrostatic sprayers. An electrostatic sprayer creates small droplets of solution and gives each droplet a positive or negative charge as it exits the sprayer nozzle. The charge on the airborne droplet attracts the droplet to the target surface, allowing for better coverage of the surface, including cracks, crevices, and other hard-to-reach areas, and more efficient use of the self-cleaning composition compared to traditional sprayers. Typically, the droplets formed are about 30 μm to about 60 μm in diameter. Electrostatic sprayers suitable for use with embodiments of methods of the invention include those commercially available from Electrostatic Spraying Systems, Inc. In some embodiments, a self-cleaning composition is applied to a surface to eliminate, substantially eliminate, or reduce the number of microbes, bacteria, viruses, or fungi.

In some embodiments, self cleaning compositions are useful to eliminate, substantially eliminate, or reduce the number of bacteria. Bacteria include, but are not limited to, pseudomonas aeruginosa, multidrug-resistant pseudomonas aeruginosa, salmonella enterica, staphylococcus aureus, listeria monocytogenes, vancomycin-resistant enterococcus faecium (VRE), methicillin-resistant staphylococcus aureus (MRSA), community-associated MRSA (CA-MRSA), community associated MRSA (CA-MRSAOPVL), escherichia coli 0157:H7, acinetobacter baumannii, campylobacter jejuni, carbapenem-resistant klebsiella pneumoniae, carbapenem-resistent klebsiella pneumonia (NDM), aspergillus niger, carbapenem-resistant enterobacteriaceae (CRE), drug-resistant neisseria gonorrhoaea, multidrug-resistant acinetobacter, drug resistant campylobacter, extended-spectrum beta-lactamase-producing enterobacteriaceae, drug resistant non-typhoidal salmonella, drug resistant salmonella typhi, drug resistant shigella, drug-resistant streptococcus pneumoniae, drug-resistant tuberculosis, vancomycin-resistant staphylococcus aureus (VRSA), erythromycin-resistant group A streptococcus, clindamycin-resistant group B streptococcus, and clostridium difficile.

In some embodiments, self cleaning compositions are useful to eliminate, substantially eliminate, or reduce the amount of virus. Viruses include, but are not limited to, parvoviridae adeno-associated virus, picornaviridae, orthomyxoviridae, caliciviridae norovirus, paramyxovirus, herpesviridae, flaviviridae, filoviridae (including ebolavirus), HIV Type 1, rotavirus, human coronavirus, avian influenza A, influenza A, influenza A (H1N1), respiratory syncytial virus, adenovirus Type 2, herpes simplex Type 1, murine norovirus, rhinovirus, polio Type 2, hepatitis B virus (HBV), and hepatitis C virus (HCV).

In some embodiments, self cleaning compositions are useful to eliminate, substantially eliminate, or reduce the amount of fungus. Fungi include, but are not limited to, fluconazole-resistant candida.

It will be appreciated by those skilled in the art that changes could be made to the exemplary embodiments shown and described above without departing from the broad inventive concepts thereof. It is understood, therefore, that this invention is not limited to the exemplary embodiments described, but it is intended to cover modifications within the spirit and scope of the present invention as defined by the claims. For example, specific features of the exemplary embodiments may or may not be part of the claimed invention and various features of the disclosed embodiments may be combined. Unless specifically set forth herein, the terms “a”, “an” and “the” are not limited to one element but instead should be read as meaning “at least one”.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

Further, to the extent that the methods of the present invention do not rely on the particular order of steps set forth herein, the particular order of the steps should not be construed as limitation on the claims. Any claims directed to the methods of the present invention should not be limited to the performance of their steps in the order written, and one skilled in the art can readily appreciate that the steps may be varied and still remain within the spirit and scope of the present invention.

### EXAMPLES

### Example 1

Effect of self-cleaning composition in accordance with an embodiment of the invention containing TiO₂ and Ag₂ on MRSA BAA. See Table 1 for test parameters.

TABLE 1

| Light source | regular office lighting (white light) |
|---|---|
| Size of slide | 1 × 1 inch |
| Original inoculum concentration | 10⁸ |
| Inoculum used | 0.03 mL |
| Amount of sanitizer used | 0.5 mL |
| Organism used | MRSA BAA 44 |
| Amount of Diluent used (DE | 5 mL |
| Neutralizer broth) | |
| Contact time | 0 min, 5 min, 30 min, and 1 hr |
| Drying time in incubator | 40 min |
| Replicates | 3 |

Procedure: Prepared 10 ml of the inoculum from a 24 hr stock culture. Aseptically added 0.03 ml inoculum to the sterile 1×1 inch slide and spread evenly. Let air dry in the incubator at 35° C. for 40 min. After air dry added 0.5 mL of the sanitizer solution to the slides. Let the slides for the contact time (for 0 min, 5 min, 30 min, and 1 hour). After each contact time, transferred the slides aseptically into sterile specimen cup and added 5 ml of the neutralizer broth (DE broth). Agitated for 5 min. on the shaker. Sub cultured on to the plates at various dilutions of (1 ml, 0.1 ml, and 0.001 ml). The plates are incubated at 35° C. for 24 hrs. The counts and dilution are recorded at 24 hours. Results are given in Table 2.

TABLE 2

| Contact Time | Raw Count (cfu) | Dilution Read (ml) | Final Count |
|---|---|---|---|
| 0 min | 216 | 0.001 | 1.1 × 10⁶ |
| | 256 | 0.001 | 1.3 × 10⁶ |
| | 224 | 0.001 | 1.1 × 10⁶ |
| 5 min | 28 | 0.01 | 1.4 × 10⁴ |
| | 120 | 0.01 | 6.0 × 10⁴ |
| | 48 | 0.01 | 2.4 × 10⁴ |
| 30 min | 34 | 0.01 | 1.7 × 10⁴ |
| | 38 | 0.01 | 1.9 × 10⁴ |
| | 12 | 0.01 | 6.0 × 10³ |
| 1 hour | 11 | 0.01 | 5.5 × 10³ |
| | 8 | 0.01 | 4.0 × 10³ |
| | 16 | 0.01 | 8.0 × 10³ |

### Example 2

Effect of self-cleaning composition in accordance with an embodiment of the invention containing TiO₂ and Ag₂ on E. coli ATCC 25922. See Table 3 for test parameters.

TABLE 3

| Light source | regular office lighting (white light) |
|---|---|
| Size of slide | 1 × 1 inch |
| Original inoculum concentration | 10⁸ |
| Inoculum used | 0.03 mL |
| Amount of sanitizer used | 0.1 mL |
| Organism used | E. coli ATCC 25922 |
| Amount of Diluent used (DE | 5 mL |
| Neutralizer broth) | |
| Contact time | 0 min, 5 min, 30 min, and 1 hr |
| Drying time in incubator | 40 min |
| Replicates | 3 |

Procedure: Prepared 10 ml of the inoculum from a 24 hr stock culture. Aseptically added 0.03 ml inoculum to the sterile 1×1 inch slide and spread evenly. Let air dry in the incubator at 35° C. for 40 min. After air dry added 0.1 mL of the sanitizer solution to the slides. Let the slides for the contact time (for 0 min, 5 min, 30 min, and 1 hour). After each contact time, transferred the slides aseptically into sterile specimen cup and added 5 ml of the neutralizer broth (DE broth). Agitated for 5 min. on the shaker. Sub cultured on to the plates at various dilutions of (1 ml, 0.1 ml, and 0.001 ml). The plates are incubated at 35° C. for 24 hrs. The counts and dilution are recorded at 24 hours. Results are given in Table 4.

TABLE 4

| Contact Time | Raw Count (cfu) | Dilution Read (ml) | Final Count |
|---|---|---|---|
| 0 min | 192 | 0.001 | 9.6 × 10⁵ |
| | 208 | 0.001 | 1.0 × 10⁶ |
| | 248 | 0.001 | 1.2 × 10⁶ |
| 5 min | 31 | 0.001 | 1.5 × 10⁵ |
| | 40 | 0.001 | 2.0 × 10⁵ |
| | 49 | 0.001 | 2.4 × 10⁵ |
| 30 min | 27 | 0.001 | 1.3 × 10⁵ |
| | 40 | 0.001 | 2.0 × 10⁵ |
| | 3 | 0.001 | 1.5 × 10⁴ |
| 1 hour | 32 | 0.001 | 1.6 × 10⁵ |
| | 42 | 0.001 | 2.1 × 10⁵ |
| | 30 | 0.001 | 1.5 × 10⁵ |

### Example 3

Test block AO56 was treated on Mar. 31, 3012 with a self-cleaning composition in accordance with an embodiment of the invention and subjected to environment similar to a front counter of a busy office where it was handled multiple times per day. The sample was tested periodically for organism growth. Results are provided in Table 5.

TABLE 5
Date collected: Aug. 7, 2013 (16 months after treatment)
Test requested: 1006 Wipe, total bacterial count
Result: 20 cfu/in²

| | | | | Possible |
|---|---|---|---|---|
| Organism isolated | Raw count | cfu/in² | % Total | Reservoirs |
| Bacilius species | 3 | 8 | 40 | Environment |
| Coag-negative | 5 | 12 | 60 | Human |
| Staphylococcus species | | | | |

Date collected: Aug. 7, 2013
Date analysed: Aug. 9, 2013 (16 months after treatment)
Test requested: 1031 Wipe, total fungal count
Result: 2 cfu/in²

| Organism isolated | Raw count | cfu/in² | % Total | MRL |
|---|---|---|---|---|
| Drechsiera species | 1 | 2 | 100 | 2 |

Date collected: Jul. 15, 2013
Date analyzed: Oct. 21, 2013 (18 months after treatment)
Test requested: 1006 Wipe, total bacterial count
Result: 425 cfu/in²

| | | | | Possible |
|---|---|---|---|---|
| Organism isolated | Raw count | cfu/in² | % Total | Reservoirs |
| Coag-negative | 17 | 425 | 100 | Human |
| Staphylococcus species | | | | |

Date collected: Jul. 15, 2013
Date analyzed: Oct. 21, 2013 (18 months after treatment)
Test requested: 1031 Wipe, total fungal count
Result: No growth
Date collected: Jan. 31, 2014
Date analyzed: Feb. 4, 2014 (22 months after treatment)
Test requested: 1006 Wipe, total bacterial count
Result: 40 cfu/in²

| | | | | Possible |
|---|---|---|---|---|
| Organism isolated | Raw count | cfu/in² | % Total | Reservoirs |
| Corynebacterium species | 8 | 20 | 50 | Human |
| Micrococcus species | 8 | 20 | 59 | Human |

Date collected: Jan. 31, 2014
Date analyzed: Feb. 4, 2014 (22 months after treatment)
Test requested: 1031 Wipe, total fungal count
Result: No growth

### Example 4

A surface was tested for microbial count (test 2056, water heterotrophic plate count SOP 2.5, Aerobiology Laboratory Associates Inc.) and found to have 50000 cfu/mL. A self-cleaning composition in accordance with an embodiment of the invention was applied to the test surface and the surface was subseqnetly tested for microbial count (test 2056, water heterotrophic plate count SOP 2.5, Aerobiology Laboratory Associates Inc.) and found to have no growth.

### Example 5

A self-cleaning composition in accordance with an embodiment of the invention inactivated murine norovirus above the cytotoxicity level following exposure for 5 minutes and 60 seconds. Results of individual tests are shown in Tables 6-9 and are summarized in Table 10. In the tables, + means CPE (cytopathic/cytotoxic effect) present), 0 means CPE (cytopathic/cytotoxic effect) not present, NT means not tested, N/A means not applicable, and CT means cytotoxicity.

TABLE 6
Test Product: NanoNano Sterisol System, Batch #1
Virus/Strain: Feline Calicivirus/F9 ATCC Cat #VR-782
Host Cell Line: CRFK Host Cell Line ATCC #CCL-94

| | | | | | Cyto- | | | |
|---|---|---|---|---|---|---|---|---|
| Dilution | Virus Control | | Test | | toxicity | Neutralization | Initial | Cell |
| (−Log₁₀) | 5 min. | 60 min. | 5 min. | 60 min. | control | Control | Populatiom | Control |
| | | | | | | | | 0000 |
| −2 | NT | NT | CT | CT | ++++ | NT | NT | N/A |
| −3 | ++++ | ++++ | 0000 | 0000 | 0000 | ++++ | ++++ | |
| −4 | ++++ | ++++ | 0000 | 0000 | 0000 | ++++ | ++++ | |
| −5 | ++++ | ++++ | 0000 | 0000 | NT | ++++ | ++++ | |
| −6 | ++++ | ++0+ | 0000 | 0000 | NT | ++++ | ++++ | |
| −7 | 0+00 | 0000 | 0000 | 0000 | NT | 0000 | ++00 | |
| TCID₅₀ | 6.75 | 6.25 | <2.50 | <2.50 | 2.50 | 6.50 | 7.00 | |
| (log₁₀) | | | | | | | | |
| Log₁₀ | N/A | N/A | 4.25 | 3.75 | N/A | | | |
| Reduction | | | | | | | | |
| Percent | | | >99.99% | 99.98% | | | | |
| Reduction | | | | | | | | |

Conclusion: The test product inactivated Feline Calicivirus above the cytotoxicity level following exposure for 5 minutes and 60 minutes.

TABLE 7
Test Product: NanoNano Sterisol System, Batch #2
Virus/Strain: Feline Calicivirus/F9 ATCC Cat #VR-782
Host Cell Line: CRFK Host Cell Line ATCC #CCL-94

| | | | | | Cyto- | | | |
|---|---|---|---|---|---|---|---|---|
| Dilution | Virus Control | | Test | | toxicity | Neutralization | Initial | Cell |
| (−Log₁₀) | 5 min. | 60 min. | 5 min. | 60 min. | control | Control | Population | Control |
| | | | | | | | | 0000 |
| −2 | NT | NT | CT | CT | ++++ | NT | NT | N/A |
| −3 | ++++ | ++++ | 0000 | 0000 | 0000 | ++++ | ++++ | |
| −4 | ++++ | ++++ | 0000 | 0000 | 0000 | ++++ | ++++ | |
| −5 | ++++ | ++++ | 0000 | 0000 | NT | ++++ | ++++ | |
| −6 | ++++ | ++0+ | 0000 | 0000 | NT | +++0 | ++++ | |
| −7 | 0+00 | 0000 | 0000 | 0000 | NT | 0000 | ++00 | |
| TCID₅₀ | 6.75 | 6.25 | ≦2.50 | ≦2.50 | 2.50 | 6.25 | 7.00 | |
| (log₁₀) | | | | | | | | |
| Log₁₀ | N/A | N/A | 4.25 | 3.75 | N/A | | | |
| Reduction | | | | | | | | |
| Percent | | | >99.99% | 99.98% | | | | |
| Reduction | | | | | | | | |

Conclusion: The test product inactivated Feline Calicivirus above the cytotoxicity level following exposure for 5 minutes and 60 minutes.

TABLE 8
Test Product: NanoNano Sterisol System, Batch #1
Virus/Strain: Murine Norovirus/S99 FLI Virus Bank Cat #RVB-651
Host Cell Line: RAW-264.7 Host Cell Line ATCC #TIB-71

| | | | | | Cyto- | | | |
|---|---|---|---|---|---|---|---|---|
| Dilution | Virus Control | | Test | | toxicity | Neutralization | Initial | Cell |
| (−Log₁₀) | 5 min. | 60 min. | 5 min. | 60 min. | control | Control | Population | Control |
| | | | | | | | | 0000 |
| −2 | NT | NT | CT | CT | ++++ | NT | NT | N/A |
| −3 | ++++ | ++++ | 0000 | 0000 | 0000 | ++++ | ++++ | |
| −4 | ++++ | ++++ | 0000 | 0000 | 0000 | ++++ | ++++ | |
| −5 | ++++ | ++++ | 0000 | 0000 | NT | ++++ | ++++ | |
| −6 | ++++ | ++++ | 0000 | 0000 | NT | ++++ | ++++ | |
| −7 | 000+ | 0000 | 0000 | 0000 | NT | 0000 | +00+ | |
| TCID₅₀ | 6.75 | 6.50 | ≦2.50 | ≦2.50 | 2.50 | 6.50 | 7.00 | |
| (log₁₀) | | | | | | | | |
| Log₁₀ | N/A | N/A | 4.25 | 4.00 | N/A | | | |
| Reduction | | | | | | | | |
| Percent | | | >99.99% | ≧99.99% | | | | |
| Reduction | | | | | | | | |

Conclusion: The test product inactivated Murine Norovirus above the cytotoxicity level following exposure for 5 minutes and 60 minutes.

TABLE 9
Test Product: NanoNano Sterisol System, Batch #2
Virus/Strain: Murine Norovirus/S99 FLI Virus Bank Cat #RVB-651
Host Cell Line: RAW-264.7 Host Cell Line ATCC #TIB-71

| | | | | | Cyto- | | | |
|---|---|---|---|---|---|---|---|---|
| Dilution | Virus Control | | Test | | toxicity | Neutralization | Initial | Cell |
| (−Log₁₀) | 5 min. | 60 min. | 5 min. | 60 min. | control | Control | Population | Control |
| | | | | | | | | 0000 |
| −2 | NT | NT | CT | CT | ++++ | NT | NT | N/A |
| −3 | ++++ | ++++ | 0000 | 0000 | 0000 | ++++ | ++++ | |
| −4 | ++++ | ++++ | 0000 | 0000 | 0000 | ++++ | ++++ | |
| −5 | ++++ | ++++ | 0000 | 0000 | NT | ++++ | ++++ | |
| −6 | ++++ | ++++ | 0000 | 0000 | NT | ++++ | ++++ | |
| −7 | 000+ | 0000 | 0000 | 0000 | NT | 0000 | +++0 | |
| TCID₅₀ | 6.75 | 6.50 | ≦2.50 | ≦2.50 | 2.50 | 6.50 | 7.25 | |
| (log₁₀) | | | | | | | | |
| Log₁₀ | N/A | N/A | 4.25 | 4.00 | N/A | | | |
| Reduction | | | | | | | | |
| Percent | | | >99.99% | ≧99.99% | | | | |
| Reduction | | | | | | | | |

Conclusion: The test product inactivated Murine Norovirus above the cytotoxicity level following exposure for 5 minutes and 60 minutes.

TABLE 10
Summary of Results

| | Feline Calicivirus | | | | Murine Norovirus | | | |
|---|---|---|---|---|---|---|---|---|
| | (ATCC# VR-782) | | | | (FBI VirusBank# RVB-651) | | | |
| | 5 minutes | | 60 minutes | | 5 minutes | | 60 minutes | |
| | Log₁₀ | % | Log₁₀ | % | Log₁₀ | % | Log₁₀ | % |
| | Reduction | Reduction | Reduction | Reduction | Reduction | Reduction | Reduction | Reduction |
| Batch 1 | 4.25 | >99.99% | 3.75 | 99.98 | 4.25 | >99.99% | 4.00 | ≧99.99% |
| Batch 2 | 4.25 | >99.99% | 3.75 | 99.98 | 4.25 | >99.99% | 4.00 | ≧99.99% |

### Example 6

A self-cleaning composition in accordance with an embodiment of the invention was dried on the plate/wells and the PEDV virus was added. Both fluorescent and UV lighting performed well, and it appears the UV light may have contributed to some virus death as well. 0 to 5 minutes results: There is no PEDV detected by titration. This was unexpected. The results are provided in Tables 11 and 12, wherein RL refers to regular light (fluorescent lighting in a biological safety cabinet), NSTOL: refers to the self-cleaning composition tested, PBS refers to phosphate buffered saline, PIM refers to post-infection media, and UV refers to Ultraviolet light (UV light in a biological safety cabinet).

TABLE 11

| | | RL + NSTOL + V | RL + PBS + V | RL + NSTOL + PIM |
|---|---|---|---|---|
| 0 | min | 0 | 6.75 | 0 |
| 5 | min | 0 | 6.5 | 0 |
| 30 | min | 0 | 7.25 | 0 |
| 1 | hr | 0 | 5.75 | 0 |
| 6 | hrs | 0 | 5.75 | 0 |

TABLE 12

| | | RL + NSTOL + V | RL + PBS + V | RL + NSTOL + PIM |
|---|---|---|---|---|
| 0 | min | 5.75 | 6.25 | 0 |
| 5 | min | 0 | 5.5 | 0 |
| 30 | min | 0 | 2.75 | 0 |
| 1 | hr | 0 | 0 | 0 |
| 6 | hrs | 0 | 0 | 0 |

I/We claim:

1. A self-cleaning composition comprising:
titanium dioxide; and
silicon dioxide.

2. The self-cleaning composition according to claim 1, further comprising an antimicrobial agent.

3. The self cleaning composition according to claim 2, wherein the antimicrobial agent comprises silver dihydrogen citrate.

4. The self-cleaning composition according to claim 1, wherein the titanium dioxide has an average particle size of about 6 nm to about 10 nm.

5. The self-cleaning composition according to claim 1, wherein the self-cleaning composition comprises from about 0.01% to about 99% by weight titanium dioxide.

6. The self-cleaning composition according to claim 1, comprising from about 0.01% to about 0.1% by weight titanium dioxide.

7. The self-cleaning composition according to claim 1, wherein the first composition comprises from about 0.001% to about 99% by weight silicon dioxide.

8. The self-cleaning composition according to claim 1, comprising from about 0.005% to about 0.01% by weight silicon dioxide.

9. The self-cleaning composition according to claim 2, comprising from about 1% to about 95% by weight antimicrobial agent.

10. The self-cleaning composition according to claim 1, wherein the self-cleaning composition is from about 0% to about 20% ionized.

11. The self-cleaning composition according to claim 1, wherein the self-cleaning composition is from about 20% to about 50% ionized.

12. The self-cleaning composition according to claim 1, wherein the self-cleaning composition is from about 50% to about 70% ionized.

13. The self-cleaning composition according to claim 1, wherein the self-cleaning composition is from about 70% to about 100% ionized.
